(19) United States
(12) Patent Application Publication
(10) Pub. No.: US 2026/0056456 A1
(43) Pub. Date: Feb. 26, 2026

(54) SHOW SET ILLUSION SYSTEMS AND METHODS

(71) Applicant: Universal City Studios LLC, Universal City, CA (US)

(72) Inventor: Peter Carsillo, Orlando, FL (US)

(21) Appl. No.: 19/303,127

(22) Filed: Aug. 18, 2025

Related U.S. Application Data
(60) Provisional application No. 63/685,095, filed on Aug. 20, 2024.

(51) Int. Cl. G03B 21/28; G03B 21/54

(52) U.S. Cl. CPC G03B 21/28; G03B 21/54

(57) ABSTRACT

A visual effects system includes a mirror structure including a mirrored surface and a non-mirrored surface. The mirrored surface extends about the non-mirrored surface and the mirrored surface and the non-mirrored surface face a guest area. The visual effects system also includes one or more props positioned proximate to the mirrored surface and extending between the mirror structure and the guest area, wherein the one or more props are oriented such that the one or more props is viewable from the guest area and a reflection of the one or more props provided by the mirrored surface is viewable from the guest area, and a projector oriented to project one or more images onto the non-mirrored surface.

### CROSS-REFERENCE TO RELATED APPLICATION

This application claims priority to and the benefit of U.S. Provisional Application No. 63/685,095, entitled “SHOW SET ILLUSION SYSTEMS AND METHODS” and filed Aug. 20, 2024, which is incorporated by reference herein in its entirety for all purposes.

### BACKGROUND

Special effects and visual effects may be used throughout amusement parks and other entertainment venues to help immerse guests in the experience of a ride or an attraction. Immersive environments may include three-dimensional (3D) props and set (e.g., show set) pieces, mechanical (e.g., robotic) elements, and/or display surfaces that present media. For example, amusement parks may provide immersive environments via a show set for guests. The show set may enable the amusement park to provide creative methods of entertaining guests, such as presenting illusions within the show set in a convincing manner.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In one embodiment, a visual effects system includes a mirror structure including a mirrored surface and a non-mirrored surface. The mirrored surface extends about the non-mirrored surface and the mirrored surface and the non-mirrored surface face a guest area. The visual effects system also includes one or more props positioned proximate to the mirrored surface and extending between the mirror structure and the guest area, wherein the one or more props are oriented such that the one or more props is viewable from the guest area and a reflection of the one or more props provided by the mirrored surface is viewable from the guest area, and a projector oriented to project one or more images onto the non-mirrored surface.

In one embodiment, a method of operating a visual effects system includes generating, at processing circuitry, image data. The method also includes instructing, via the processing circuitry, transmission of the image data to a projector, wherein the projector is configured to project one or more images based on the image data, and displaying, using a non-mirrored surface of a mirror structure, the one or more images projected by the projector. The method further includes providing a reflection of one or more props using a mirrored surface extending circumferentially about the non-mirrored surface to enable visualization of the reflection from a guest area and to provide an illusion of extension of the one or more props resulting from combined viewing of the one or more props and the reflection from the guest area.

In one embodiment, a visual effects system includes one or more panels including a mirrored surface and a non-mirrored surface, wherein the mirrored surface circumscribes the non-mirrored surface from a viewing perspective of a guest area, and a prop positioned between the one or more panels and the guest area. The visual effects system also includes a projector configured to project imagery onto the non-mirrored surface, wherein the prop aligns with a reflection of the prop provided by the mirrored surface from the viewing perspective of the guest area to provide an illusion of the prop extending beyond the mirrored surface and into the projected imagery.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an attraction that includes a visual effects system, in accordance with an embodiment of the present disclosure;

FIG. 2 is a perspective view of the visual effects system, in accordance with an embodiment of the present disclosure;

FIG. 3 is a plan view of a mirror structure of the visual effects system, in accordance with an embodiment of the present disclosure; and

FIG. 4 is a perspective view of the mirror structure and one or more props of the visual effects system, in accordance with an embodiment of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure is directed to a visual effects system that provides visual effects (e.g., illusions) for an attraction (e.g., show set). The visual effects system may operate in any of a variety of venues, such as in an amusement park, a restaurant, a hotel, a theatre, a stadium, and so forth. The venue may include a variety of features, such as rides (e.g., a roller coaster), theatrical shows, set designs, performers, and/or decorative elements, to entertain guests. The visual effects may be used to supplement or complement the features, such as to provide the guests with a more immersive and/or unique experience. For example, the visual effects may be presented to emulate real-world elements in order to present a more realistic, believable, and yet fantastic atmosphere for the guests.

The visual effects system may include a mirror structure, one or more props, a blockage (e.g., screen, obstruction, shield, barrier, cover, scrim), and a projecting device (e.g., an image projector). The mirror structure may be positioned at a height above a guest and/or in a central location relative to a floor (e.g., ground, surface) or guest area of an attraction. At least a portion of the mirror structure may include a non-mirrored surface, which may be feathered (e.g., blended, softened) at edges of the non-mirrored surface. For example, the non-mirrored surface of the mirror structure may include a coating (e.g., coating of paint, plastic, rubber) disposed (e.g., sprayed) on a central portion of a mirror or the non-mirrored surface may be an exposed surface (e.g., a surface of a wooden or plastic substrate) with a mirrored coating surrounding it. The feathering is essentially a blended area of mirrored and non-mirrored surfaces to camouflage the transition between mirroring and non-mirroring. The feathering may be achieved with blending via pixilation, coating with thin lines, or other forms of blending (e.g., blending a coating).

In one embodiment, the mirrored surface and/or the non-mirrored surface may include black masking at outermost edges (e.g., outside of the feathered edges) of the non-mirrored surface. Additionally, the one or more props may be positioned directly beneath a portion of the mirror structure that is at least partially mirrored (e.g., not entirely covered by the non-mirrored surface or the entirely exposed non-mirrored surface of the mirror structure). In one embodiment, the one or more props may extend from directly beneath the mirror structure downward toward the floor or the guest area of the attraction. Thus, the mirrored surface (e.g., the uncovered mirror portion or exposed mirror portion) of the mirror structure may facilitate reflection of the one or more props. When the one or more props extend a sufficient distance relative to the mirror structure and the mirror is properly oriented, a corresponding reflection of the one or more props generates an illusion of infinity for viewers in a guest area (e.g., standing on a floor beneath the mirror structure).

The projecting device and/or the blockage may be positioned within the guest area of the attraction. Further, the projecting device may be hidden from a view of the guest via the blockage. The blockage blocks (e.g., reflects) light, at least partially. For example, the blockage may include a woven material that prevents observers from seeing through the blockage to observe the projecting device (e.g., projector) disposed therein. To enable the guest to view imagery on the non-mirrored surface, the projecting device may project one or more images (e.g., animation or other video imagery) onto the non-mirrored surface. In this manner, the visual effects system may provide an illusion of an extension (e.g., elongation, lengthening, expansion) of the one or more props into projected content (e.g., images of clouds) via reflection of the one or more props and the projected one or more images. This illusion is achieved while substantially concealing the nature of the illusion by blocking viewing of the projector and by the non-mirrored surface not reflecting views beneath certain parts of the mirror structure. For example, the non-mirrored surface is positioned relative to the projecting device and the guest area to avoid observers from the guest area (e.g., positioned on the floor) seeing themselves and/or other reflections (e.g., reflected flooring) in the reflection of the mirror structure.

As an example, the one or more props may include a building (e.g., high-rise office building). The building may be positioned directly beneath the mirrored surface of the mirror structure and extend downward to the surface of the guest area. Therefore, the building may reflect off of the mirrored surface of the mirror structure. The projecting device may project the one or more images, such as images of one or more clouds onto the non-mirrored surface to create the illusion of extension of the view beyond the mirror structure and into the clouds. As such, the visual effects system may provide the illusion of the building essentially infinitely extending into a ceiling of the attraction via reflection of the building off of the mirrored surface of the mirror structure and the projected images of the one or more clouds.

Regarding this example, aspects of the building, including an interior of the building (e.g., interior office space), may also be reflected by the mirroring. For example, objects (e.g., fixtures and furniture) disposed within the building (especially for floors near the mirror structure) may be reflected. However, the reflection will be inverse. Accordingly, to further immersion in the illusion, certain objects may be positioned upside down. For example, what would normally be overhead light fixtures may be positioned such that they extend up from the floor of an office proximate to the mirror structure. Thus, the reflection of this office space will create the illusion of looking up at a ceiling of the next higher office. Further, the building may be generally uniform in structure and pattern (e.g., a repetitive and invertible external appearance) to facilitate the extension illusion provided by mirroring.

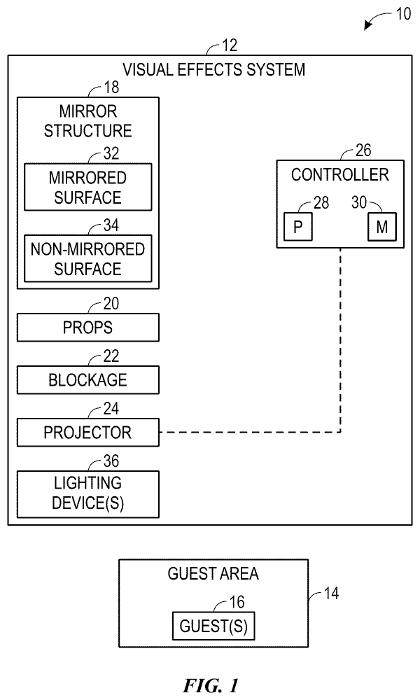

With the foregoing in mind, FIG. 1 is a schematic diagram of an attraction 10 (e.g., environment, venue) that includes a visual effects system 12, in accordance with an embodiment of the present disclosure. The attraction 10 may include a guest area 14 where one or more guests 16 may be positioned. As an example, the guest area 14 may include a space (e.g., a seating area, a walkable area) where the one or more guests 16 may be positioned to view a performance or a show set of the attraction 10. As another example, the guest area 14 may include a ride vehicle that may move and carry the one or more guests 16 throughout the attraction.

Furthermore, the attraction 10 may include the visual effects system 12 that may provide visual effects (e.g., illusions) to the one or more guests 16 located in the guest area 14 and/or in the attraction 10. For example, the visual effects system 12 may create visual effects that are viewable by the one or more guests 16. The visual effects system 12 may include a mirror structure 18, one or more props 20, a blockage 22 (e.g., screen, obstruction, shield, barrier, cover, scrim), a projecting device 24 (e.g., an image projector), and a controller 26 (e.g., an electronic controller, programmable logic controller, distributed control system). The controller 26 may include one or more processors 28 (referred to herein, in singular form, as a “processor 28” for convenience) and memory 30 (e.g., one or more memories, such as a hard drive or cloud storage).

The processor 28 (which may represent one or more processors) may be any type of computer processor or microprocessor capable of executing computer-executable code, which may be stored on the memory 30. The processor 28 may also include multiple processors, processing circuitry, or a processing system that may perform the operations described herein. The memory 30 may include a volatile memory, such as random-access memory (RAM), and/or a nonvolatile memory (ROM). The memory 30 may store a variety of information and may be used for various purposes. For example, the memory 30 may store processor-executable instructions, such as instructions for projecting the visual effects. The memory 30 may also include flash memory, or any suitable optical, magnetic, or solid-state storage medium, or a combination thereof. The memory 30 may store data, instructions (e.g., software or firmware), and any other suitable information.

In one embodiment, the mirror structure 18 may be positioned at a height above the guest area 14 and/or in a central location relative to a floor (e.g., ground, surface) or the guest area 14 of the attraction 10. Additionally or alternatively, the mirror structure 18 may be positioned inverted and/or on its side, proximate (e.g., adjacent) to the guest area 14 where the one or more guests 16 may be. For example, the mirror structure 18 may be positioned along a corridor (e.g., hallway) extending away from the guest area 14. The corridor may extend above, below, and/or horizontally away from the guest area 14. As another example, the mirror structure 18 may include one or more panels, one or more reflectors, one or more coatings, one or more screens, and/or any other suitable mirror-like structure.

The mirror structure 18 may include a stretch ceiling system (e.g., a Barrisol mirror), such as a ceiling installation where a flexible and reflective material is stretched and secured on a particular framework. Indeed, at least a portion of the mirror structure 18 may include a mirror material, such as a flexible polyvinyl chloride (PVC), which may be treated or coated to be highly reflective. In this manner, the stretch ceiling system may create a reflective surface that mimics an appearance of a traditional glass mirror, while maintaining lightweight, flexibility, and providing ease of installation. It should be noted that while the mirror structure 18 is described as a single mirror structure, the mirror structure 18 may include any suitable number of mirrors.

Further, the mirror structure 18 may include a mirrored surface 32 and/or a non-mirrored surface 34. In other words, at least a portion of the mirror structure 18 may be the mirrored surface 32 and at least a portion the mirror structure 18 may be the non-mirrored surface 34. The mirrored surface 32 and the non-mirrored surface 34 may face the guest area 14. For example, the mirrored surface 32 and the non-mirrored surface 34 may be inverted, positioned above the guest area 14, positioned proximate (e.g., adjacent) to the guest area 14 (e.g., by positioning the mirror structure 18 on its side), and/or in any other suitable orientation relative to the guest area 14. In one embodiment, the mirrored surface 32 and the non-mirrored surface 34 may be separate or offset components of the mirror structure 18.

In one embodiment, the mirrored surface 32 may be the base which is coated by the non-mirrored surface 34 and/or may extend about the non-mirrored surface 34. For example, the mirrored surface 32 may extend about an external circumference (e.g., circumferentially) of the non-mirrored surface 34. In another embodiment, the non-mirrored surface 34 may be the base which is covered by the mirrored surface 32. In another embodiment, a central portion (e.g., a central section, generally circular portion centered at a midpoint) of the mirror structure 18 may include the non-mirrored surface 34 to facilitate projection of imagery onto the central portion.

The non-mirrored surface 34 of the mirror structure 18 may include a coating (e.g., paint, plastic, rubber) disposed (e.g., sprayed, brushed) on the central portion of the mirror structure 18. As another example, the non-mirrored surface 34 of the mirror structure 18 may be an exposed surface (e.g., a surface of a wooden or plastic substrate) with a mirrored coating (e.g., the mirrored surface 32) surrounding it. It should be noted that while the central portion of the mirror structure 18 is described as including the non-mirrored surface 34, the non-mirrored surface 34 may be included in any suitable location of the mirror structure 18 to facilitate a desired reflective configuration.

The non-mirrored surface 34 of the mirror structure 18 may be feathered (e.g., blended, softened) at edges of the non-mirrored surface 34, such as at edges of the coating. The feathered edges may form a juncture between the mirrored surface 32 and the non-mirrored surface 34. In this manner, the feathered edges may visually appear to be a smooth transition between the mirrored surface 32 and the non-mirrored surface 34. This camouflages the transition for viewers. The non-mirrored surface 34 may be a uniform, consistent shape or may be irregularly shaped, depending on a desired illusion. For example, the non-mirrored surface 34 may be shaped specifically to accommodate content (e.g., the one or more images, animation, and/or other video imagery) being displayed onto the non-mirrored surface 34. Additionally or alternatively, the non-mirrored surface 34 and/or the mirrored surface 32 may include a black masking at outermost edges (e.g., outside of the feathered edges) of the non-mirrored surface 34. The black masking may obstruct and/or minimize reflections of the mirror structure 18 where the black masking is located. For example, the black masking may prevent the one or more guests 16 from observing their own reflection while moving (e.g., traversing) around the guest area 14, which would potentially unmask the illusion.

As described herein, the visual effects system 12 may include the one or more props 20. As an example, the one or more props 20 may include buildings, statues, furniture, streetlamps, vehicles, signage (e.g., banners), and/or any other suitable prop or themed decoration for a particular scene of the attraction 10. The one or more props 20 may be positioned proximate to the mirrored surface 32, such as directly beneath the mirror structure 18 at the mirrored surface 32 of the mirror structure 18. In one embodiment, the one or more props 20 may extend from directly beneath the mirror structure 18 downward toward the floor of the guest area 14 of the attraction 10. Thus, the mirrored surface 32 (e.g., a portion of the mirror structure 18 not covered by the coating) may facilitate reflection of the one or more props 20. As an example, the one or more props 20 may be oriented such that the one or more props 20 are viewable by the guests 16 in the guest area 14 and the reflection of the one or more props 20 are viewable by the guests 16 in the guest area. Moreover, the reflection of the one or more props 20, along with their positioning, may create an illusion of an extension (e.g., into the ceiling) of a view of the one or more props 20. When an illusion of infinite extension is desired, it may be important for the props 20 to extend down far enough to establish the illusion and for the props 20 to be somewhat uniform in outward appearance to accommodate the repetitive nature of the reflection.

Further, the visual effects system 12 may include the blockage 22 and/or the projecting device 24. The blockage 22 and/or the projecting device 24 may be positioned within the guest area 14 of the attraction 10 below the mirror structure 18. For example, the projecting device 24 may be positioned behind and/or within the blockage 22 (e.g., foliage, a wall, structure) in a central portion of the guest area 14. In one embodiment, the blockage 22 blocks (e.g., reflects) light, at least partially. For example, the blockage 22 may include a woven material that prevents the one or more guests 16 from seeing through the blockage 22. In this manner, the projecting device 24 may be hidden from a view of the one or more guests 16.

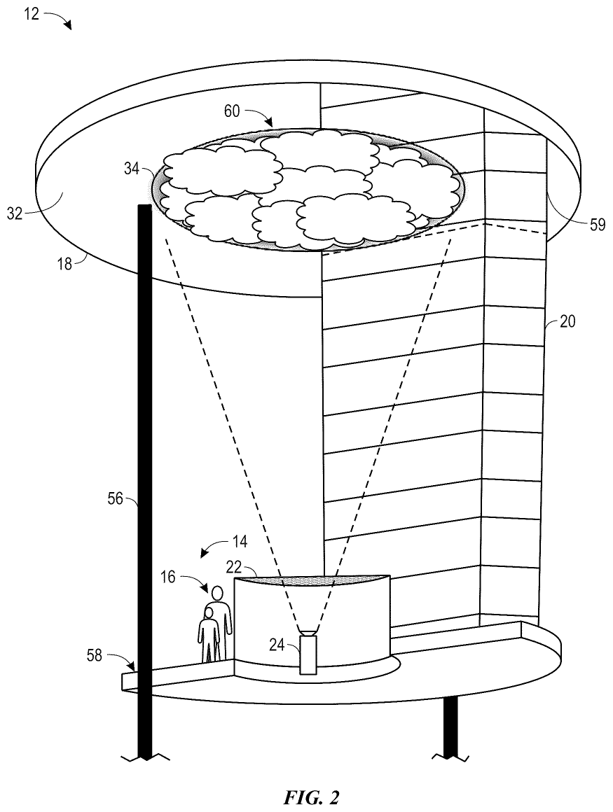

Further, the projecting device 24 may be positioned (e.g., oriented) to project one or more images (e.g., animation or other video imagery) onto the non-mirrored surface 34 of the mirror structure 18 from any suitable area of the guest area 14. As an example, the projecting device 24 may be positioned on a surface 58 (FIG. 2) (e.g., flooring) of the guest area 14 and pointing upwards to project the one or more images above. Alternatively, the projecting device 24 may be placed on its side to project the one or more images horizontally.

As another example, the projecting device 24 may be positioned on the top of a tree (e.g., a fake tree), statue, or fountain and may operate to project imagery upwardly onto the mirror structure 18 such that the guests 16 in the guest area 14 cannot see the projecting device 24. In these embodiments, aspects of the tree, statue, or fountain may be the blockage 22. The controller 26 may generate image data and transmit the image data to the projecting device 24 to cause the projecting device 24 to project the one or more images onto the mirror structure 18. The one or more images may further create the illusion of the extension of the view of the one or more props 20. For example, the one or more images may depict clouds and coordinate to provide an illusion of the reflected props 20 extending beyond the clouds and out of sight.

In one embodiment, at least a portion of the mirror structure 18 may include a semi-translucent material that may enable light to pass through. For example, the mirrored surface 32 may include a partially reflective and partially translucent film that performs differently based on lighting. Further, one or more lighting devices 36 may be positioned above or behind the mirror structure 18 (e.g., on a side opposite the one or more guests 16). The one or more lighting devices 36 may be controlled or instructed (e.g., by the controller 26) to produce additional visual effects behind the mirror structure 18 based on lighting conditions. For example, the one or more lighting devices 36 may include a spotlight, which may be activated by the controller 26 to light up a ride vehicle, a prop, or the like such that the ride vehicle, the prop, or the like can be seen through the mirror structure 18 from the guest area 14. As such, the one or more lighting device 36 may enable the visual effects system 12 to create an illusion of, for example, the ride vehicle flying through clouds or some other projected content.

As another example, the one or more lighting devices 36 may be respectively coupled to one or more actuators. The one or more lighting devices 36 may then be instructed by the controller 26 to display one or more images (e.g., ghosts). The controller 26 may actuate the one or more actuators to move the one or more lighting devices 36 and give the illusion of movement of the one or more images (e.g., ghosts) above the mirror structure 18.

With the foregoing in mind, FIG. 2 is a perspective view of the visual effects system 12, in accordance with an embodiment of the present disclosure. As described herein, the visual effects system 12 may include the mirror structure 18 with the mirrored surface 32 and/or the non-mirrored surface 34. In one embodiment, the mirror structure 18 may be supported by a structural support 56 (e.g., beams, frames, columns). Further, in one embodiment, the structural support 56 may be reflected in the mirrored surface 32. While the illustrated embodiment depicts the structural support 56 extending downward from the mirror structure 18 and supporting it from below, it should be noted that the structural support 56 may suspend the mirror structure 18 from above (e.g., from a ceiling). Further, multiple structural supports 56 may support the structure from above and/or below. Further, as described herein, the visual effects system 12 may also include the one or more props 20.

As an example, as illustrated in FIG. 2, a prop of the one or more props 20 may include a building. The building may be positioned directly beneath the mirrored surface 32 and extend downward to a surface 58 (e.g., flooring) of the guest area 14. Therefore, the building may reflect off of the mirrored surface 32 of the mirror structure 18, as indicated by reflection 59. It should be noted that the one or more props 20 may include any suitable prop and/or themed decoration for the attraction 10 (FIG. 1). Additionally, it should be noted that each prop 20 of the one or more props 20 may be positioned at any suitable location within the attraction 10. Indeed, at least some of the one or more props 20 may be positioned directly beneath the mirrored surface 32 to enable the reflection 59 of the at least some of the one or more props 20 off of the mirrored surface 32. If an illusion of essentially infinite extension is desired, it may be preferable for a particular one of the props 20 to extend all the way to the surface 58 of the guest area 14, such as the floor. However, if an illusion of floating it desired, it may be desirable for the particular one of the props 20 to extend only partially downward from the mirror structure 18.

The visual effects system 12 may include the projecting device 24 disposed behind the blockage 22 within the guest area 14. In this manner, the projecting device 24 may be hidden from the view of the one or more guests 16 as the one or more guests 16 move around the guest area 14 of the attraction 10 (FIG. 1). The blockage 22 may at least partially block (e.g., reflect) light. In one embodiment, the blockage 22 may include any suitable prop of the one or more props 20 or a themed decoration of the attraction 10. As an example, the blockage 22 may include a statue with a hollow interior to house the projecting device 24. In this manner, the projecting device 24 may be hidden from view of the one or more guests 16.

As an example, the projecting device 24 may emit light (e.g., one or more images 60) via one or more openings (e.g., discreet openings hidden from the view of the one or more guests 16) in the blockage 22 (e.g., a statue) onto the non-mirrored surface 34. Indeed, the controller 26 (FIG. 1) may generate image data and transmit the image data to the projecting device 24 to cause (e.g., instruct) the projecting device 24 to project the one or more images 60 onto the mirror structure 18. That is, the projecting device 24 may project the one or more images 60 onto the non-mirrored surface 34 for visualization by the one or more guests 16. For example, the one or more images 60 may include imagery of the one or more clouds or animation of movement of the one or more clouds across the non-mirrored surface 34. Further, the one or more props 20 may align with the reflection 59 of the one or more props 20 from a viewing perspective of the guest area 14 to provide an illusion of the one or more props 20 extending beyond the mirrored surface 32 and into the one or more images 60.

In one embodiment, the coating of the non-mirrored surface 34 may be a neutral color (e.g., white, gray, beige, or any other suitable color) to enable visualization of the one or more images 60 projected onto the non-mirrored surface 34. The projecting device 24 may be positioned such that the one or more images 60 are projected directly onto the non-mirrored surface 34 of the mirror structure, such as at the surface 58 of the guest area 14 below the mirror structure 18. For example, the projecting device 24 may be positioned directly beneath the non-mirrored surface 34, which is mounted on a ceiling of the attraction 10 (FIG. 1), and angled upwards to project onto the non-mirrored surface 34. As such, the one or more guests 16 may view the one or more images 60 on the mirror structure 18 from any suitable position within the guest area 14. In this manner, the visual effects system 12 may create the illusion of the building extending beyond a ceiling of the attraction 10 via the reflection 59 of the building off of the mirrored surface 32 and the projected images (e.g., the one or more clouds).

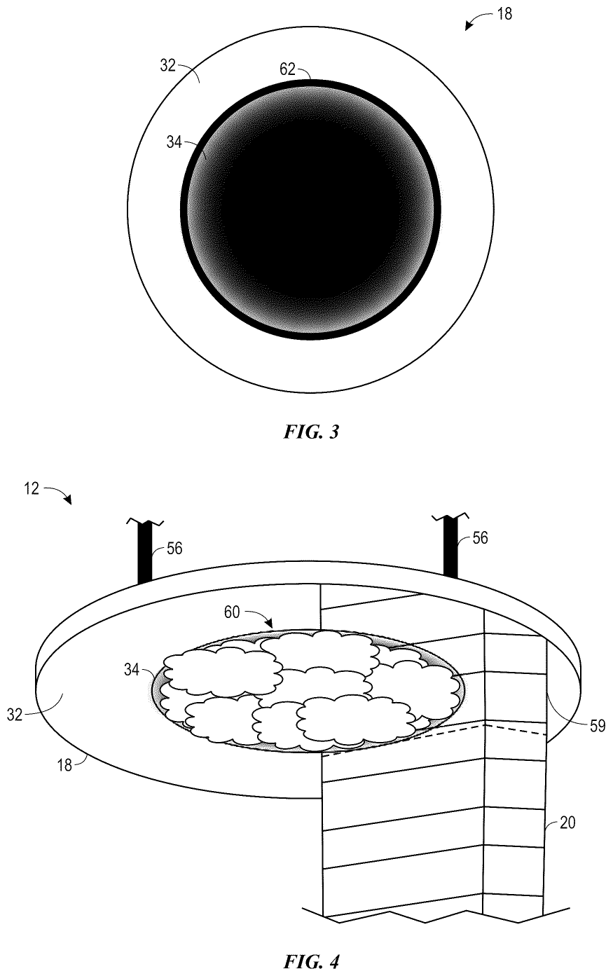

FIG. 3 is a plan view of the mirror structure 18 of the visual effects system 12 (FIG. 1), in accordance with an embodiment of the present disclosure. As illustrated, FIG. 3 is the plan view of the mirror structure 18 prior to projection of the one or more images 60 (FIG. 2) onto the non-mirrored surface 34. As described herein, the mirror structure 18 may include the mirrored surface 32 and/or the non-mirrored surface 34. The mirrored surface 32 may include any suitable reflective surface. The non-mirrored surface 34 may include the coating disposed on the mirror structure 18. The coating may be applied in a uniform manner, which may create a consistent shape. Alternatively, the coating may be applied in an inconsistent manner, which may create an irregular shape. Indeed, the coating may be applied uniformly or inconsistently based on content (e.g., the one or more images 60, animation, and/or other video imagery) being displayed onto the non-mirrored surface 34. It should be noted that, in an embodiment, the non-mirrored surface 34 may not be coated onto the mirrored surface 32. For example, the non-mirrored surface 34 may be a layer (e.g., a base layer) that is applied before the mirrored surface 32 or that is exposed by removing a portion of the mirrored surface 32.

Further, the coating of the non-mirrored surface 34 may be feathered at the edges of the non-mirrored surface 34. For example, a coating or substrate providing the non-mirrored surface 34 may gradually reduce in thickness, coverage, surface area, and/or intensity at the edges of the non-mirrored surface 34 to enable a smooth blend between the non-mirrored surface 34 and the mirrored surface 32. That is, the feathering may enhance the illusion provided by the visual effects system 12 by reducing noticeable edges and/or distinctions between the non-mirrored surface 34 and the mirrored surface 32. In addition, the feathering may obstruct and/or minimize reflections of the one or more guests 16 (FIG. 1) and/or any suitable prop of the one or more props 20 (FIG. 1) within the attraction 10 (FIG. 1) that are not intended to be shown in the reflection 59 (FIG. 2) of the mirrored surface 32.

In one embodiment, the mirror structure 18 may also include a black masking 62 at outermost edges (e.g., outside of the feathered edges) of the non-mirrored surface 34. That is, a black (e.g., or similar color) material (e.g., paint, plastic, rubber) may be applied to the outermost edges of the non-mirrored surface 34. The black masking 62 may define the outermost edges of the non-mirrored surface 34 and/or improve visual contrast between the mirrored surface 32 and the non-mirrored surface 34. Moreover, the black masking 62 may prevent reflection of light, the one or more guests 16 (FIG. 1), the one or more props 20 (FIG. 1), and/or any suitable surface of the guest area 14 (FIG. 1) in certain portions of the mirror structure 18, such as the mirrored surface 32 and/or the non-mirrored surface 34. Indeed, the black masking 62 may block the reflection of the light and reflection of any suitable object not intended to be shown to the one or more guests 16 within the attraction 10 (FIG. 1). Accordingly, the mirror structure 18 may enable the visual effects system 12 (FIG. 1) to provide the one or more illusions for the attraction 10 via the mirror structure 18, which includes the mirrored surface 32, the non-mirrored surface 34, and/or the black masking 62. The black masking 62 may include any essentially non-reflective camouflaging coating, coloring, texture, or the like.

FIG. 4 is a perspective view of the mirror structure 18 and the one or more props 20 of the visual effects system 12, in accordance with an embodiment of the present disclosure. As illustrated, FIG. 4 is the perspective view of the mirror structure 18 during projection of the one or more images 60 onto the non-mirrored surface 34. As described herein, the mirror structure 18 may be supported by the structural support 56. For example, the structural support 56 may suspend the mirror structure 18 from above (e.g., from the ceiling). The controller 26 (FIG. 1) may transmit the image data to the projecting device 24 (FIG. 1) to cause the projecting device 24 to project the one or more images 60 onto the non-mirrored surface 34. For example, as illustrated in FIG. 4, the one or more images 60 may include the one or more clouds.

In addition, as illustrated, the one or more props 20 may include the building (or representation of a building) positioned directly beneath (e.g., at least a portion is directly beneath) the mirrored surface 32. As such, the building may reflect off of the mirrored surface 32 of the mirror structure 18. In this manner, the projected one or more images 60 of the one or more clouds onto the non-mirrored surface 34 and the reflection 59 (e.g., as indicated in FIG. 4 by a dashed line) of the building on the mirrored surface 32 may enable visualization of the illusion of the building extending beyond the mirror structure 18, which should be perceived as the clouds and an extension of the building.

Accordingly, the visual effects system 12 may provide an immersive environment by presenting one or more illusions to the one or more guests 16 (FIG. 1) within the attraction 10 (FIG. 1). Indeed, the visual effects system 12 may provide the illusion of the extension of the one or more props 20 via the reflection 59 of the one or more props 20 on the non-mirrored surface 34 and the one or more images 60 projected onto the non-mirrored surface 34. That is, the reflection 59 of the one or more props 20 enables visualization of the reflection 59 from the guest area 14 (FIG. 1) to provide the illusion of the extension of the one or more props 20 resulting from a combined viewing of the one or more props 20 and the reflection 59 from the guest area 14. As such, the illusion may emulate real-world elements, such as buildings or any other suitable theatrical decor, within the attraction 10 to present a more realistic and believable fantastical atmosphere and/or unique experience to the one or more guests 16.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A visual effects system, comprising:
a mirror structure comprising a mirrored surface and a non-mirrored surface, wherein:
the mirrored surface extends about the non-mirrored surface; and
the mirrored surface and the non-mirrored surface face a guest area;
one or more props positioned proximate to the mirrored surface and extending between the mirror structure and the guest area, wherein the one or more props are oriented such that the one or more props is viewable from the guest area and a reflection of the one or more props provided by the mirrored surface is viewable from the guest area; and
a projector orientated to project one or more images onto the non-mirrored surface.

2. The visual effects system of claim 1, wherein the mirror structure is positioned along a corridor extending away from the guest area.

3. The visual effects system of claim 2, wherein the corridor extends above, below, or horizontally away from the guest area.

4. The visual effects system of claim 1, comprising feathering of the mirrored surface and/or the non-mirrored surface forming a juncture between the mirrored surface and the non-mirrored surface.

5. The visual effects system of claim 1, wherein the mirrored surface extends about an external circumference of the non-mirrored surface.

6. The visual effects system of claim 1, comprising one or more lighting devices disposed behind the mirror structure relative to guest area, wherein the mirrored surface is partially translucent and partially reflective.

7. The visual effects system of claim 6, comprising a controller configured to control the one or more lighting devices to display one or more additional images.

8. The visual effects system of claim 1, comprising:
a controller, wherein the controller comprises a processing system and a memory, and wherein the memory is encoded with instructions configured to be executed by the processing system to cause the controller to:
generate image data; and
transmit the image data to the projector to cause the projector to display the one or more images.

9. The visual effects system of claim 1, comprising a blockage, wherein the projector is positioned behind the blockage relative to the guest area, within the blockage, or both.

10. The visual effects system of claim 9, wherein the blockage is configured to at least partially reflect light.

11. The visual effects system of claim 1, comprising a prop of the one or more props that is positioned directly beneath the mirrored surface and extends to a floor of the guest area.

12. The visual effects system of claim 1, wherein the non-mirrored surface comprises a coating disposed on a central portion of the mirror structure and the coating comprises paint, plastic, rubber, or any combination thereof.

13. The visual effects system of claim 1, wherein the non-mirrored surface comprises a black masking disposed at one or more outer edges of the non-mirrored surface.

14. The visual effects system of claim 1, wherein the mirrored surface and the non-mirrored surface are separate or offset components of the mirror structure.

15. The visual effects system of claim 1, wherein the one or more props align with the reflection of the one or more props from a viewing perspective of the guest area to provide an illusion of the one or more props extending beyond the mirrored surface and into the projected one or more images.

16. A method of operating a visual effects system, the method comprising:
generating, at processing circuitry, image data;
instructing, via the processing circuitry, transmission of the image data to a projector, wherein the projector is configured to project one or more images based on the image data;
displaying, using a non-mirrored surface of a mirror structure, the one or more images projected by the projector; and
providing a reflection of one or more props using a mirrored surface extending circumferentially about the non-mirrored surface to enable visualization of the reflection from a guest area and to provide an illusion of extension of the one or more props resulting from combined viewing of the one or more props and the reflection from the guest area.

17. The method of claim 16, comprising obstructing, using a blockage, viewing of the projector from the guest area.

18. The method of claim 16, comprising actuating, using one or more actuators, lighting disposed behind the mirrored surface relative to the guest area, wherein the mirrored surface comprises a partially reflective and partially translucent material.

19. A visual effects system, comprising:
one or more panels comprising a mirrored surface and a non-mirrored surface, wherein the mirrored surface circumscribes the non-mirrored surface from a viewing perspective of a guest area;
a prop positioned between the one or more panels and the guest area; and
a projector configured to project imagery onto the non-mirrored surface, wherein the prop aligns with a reflection of the prop provided by the mirrored surface from the viewing perspective of the guest area to provide an illusion of the prop extending beyond the mirrored surface and into the projected imagery.

20. The visual effects system of claim 19, comprising:
a blockage configured to block viewing of the projector from within the guest area
a plurality of props positioned between the one or more panels and the guest area; and
feathering of the mirrored surface and/or the non-mirrored surface, wherein the feathering forms a juncture between the mirrored surface and the non-mirrored surface.
